(19) United States
(12) Patent Application Publication
(10) Pub. No.: US 2018/0319689 A1
(43) Pub. Date: Nov. 8, 2018

(54) PURIFICATION OF AQUEOUS SOLUTIONS FROM METAL CONTAMINATION WITH ACTIVATED MANGANESE DIOXIDE

(71) Applicant: J.S. Meyer Engineering, P.C., Belleville, IL (US)

(72) Inventor: Stanley M. MEYER, Maryville, IL (US)

(73) Assignee: J.S. Meyer Engineering, P.C., Belleville, IL (US)

(21) Appl. No.: 15/980,763

(22) Filed: May 16, 2018

Related U.S. Application Data
(63) Continuation-in-part of application No. 14/069,211, filed on Oct. 31, 2013.
(60) Provisional application No. 61/790,313, filed on Mar. 15, 2013.

(51) Int. Cl. C02F 9/00; C01G 45/02

(52) U.S. Cl. CPC C02F 9/00; C02F 2103/10; C01G 45/02

(57) ABSTRACT

The present disclosure relates, according to some embodiments, to systems and methods for removal of contaminants from water including, but not limited to, industrial wastewater, brackish water, municipal wastewater, drinking waters, and particularly waters obtained from fracking operations. For example, a method for purifying a feed water composition may comprise (a) contacting the feed water composition with an activated manganese dioxide to form an activated manganese dioxide-containing feed water composition, where the activated manganese dioxide was formed by contacting soluble organics with soluble permanganate ions (MnO₄⁻) at a pH from about 5.5 to about 14; (b) increasing the pH of the activated manganese dioxide-containing feed water composition sufficient to form a contaminant precipitate and an alkaline solution, wherein the contaminant precipitate comprises at least some of the metal; (d) removing the contaminant precipitate from the alkaline solution to form a treated water, wherein the treated water is purified relative to the feed water composition. The activated manganese dioxide material may be formed in situ by adding the soluble permanganate ions to the feed water composition where the permanganate will react with the contained proper organic or a proper organic added to the feed water composition, such as glycerin. In the alternative, the activated manganese dioxide can be formed in vitro by reacting the soluble permanganate ions with the proper organic, and the resulting activated manganese dioxide can thereafter be added to the feed water composition. Optionally, the pH of treated water can be lowered, for example to a pH suitable for transportation or for further industrial use, such as liquid road salt. In addition, either or both the feed water composition and the treated water can be exposed to activated carbon. Further yet, the treated water can be exposed to ultraviolet (UV) light. The treated water is then suitable for industrial purpose, such as liquid road salt.

### CROSS-REFERENCE TO RELATED APPLICATIONS

This patent application claims benefit to U.S. patent application Ser. No. 14/069,211 filed on Oct. 31, 2013, which claims benefit to U.S. Provisional Patent Application No. 61/721,309 filed on Nov. 1, 2012, and to U.S. Provisional Patent Application No. 61/790,313 filed on Mar. 15, 2013. The contents of U.S. patent application Ser. No. 14/069,211 and US Provisional Patent Application Nos. 61/721,309 and 61/790,313 are hereby incorporated in their entirety by reference.

### FIELD OF THE DISCLOSURE

The present disclosure relates, in some embodiments, to systems and methods for and products of the recovery, purification, and reuse of contaminated water including, for example, treatment of water produced by oil and gas field operations.

### BACKGROUND OF THE DISCLOSURE

Deep well injection is an often used method of disposing of metal containing water wastes. The waste is concentrated and injected into deep aquifers for disposal. Recently, injection of these materials has been suspected of causing slippage and subsequent mini earthquakes. This puts contamination of the higher level potable water aquifers at risk.

A recent large volume addition to this disposal solution is the produced water from oil and gas fields. Recent recycling techniques have reduced the amount of fresh water used but the increased number of wells has increased the amount of highly contaminated produced water. Injection of this material has been suspended in several states. This has led to increased storage of other contaminated wastes which are commonly deep well injected.

Disposal techniques may include biologically treating the water and subsequently evaporating it to separate it from contaminating constituents. Evaporation produces a pure water fraction and concentrated brine fraction. Concentrated brine may be filtered to produce filtered sludge and a filtered concentrated brine. Filtered concentrated brine may be stored or transported to deep well injection sites while filtered sludge may require disposal at a controlled land fill site. Current recovery and disposal methods may be costly including considerable energy costs for evaporation operations and disposal costs for filtered sludge. In addition, waste stored on the site of a failed drilling company may become a federal or state obligation for disposal, such as the current super fund sites.

### SUMMARY

Accordingly, a need has arisen for improved recovery and purification technique which is capable of removing contaminants from water with reduced energy expenditures, disposal costs, and the ability to reuse the purified product. The method disclosed herein allows for the reuse of the purified product in industrial applications and disposal of the solids produced in qualified landfills, thus eliminating the need for deep well injection.

The present disclosure relates, according to some embodiments, to removal of contaminants from water including, but not limited to, industrial wastewater, brackish water, municipal wastewater, drinking waters, and particularly waters obtained from oil and gas operations, such as fracking operations. Contaminants removed may include aluminum, barium, boron, calcium, iron, magnesium, manganese, strontium, and sulfur, and any other divalent or trivalent metals. For example, a method for purifying a feed water composition from metals may comprise (a) contacting the feed water composition with an activated manganese dioxide to form an activated manganese dioxide-containing feed water composition, where the activated manganese dioxide was formed by contacting soluble organics with soluble permanganate ions (MnO₄⁻) at a pH from about 5.5 to about 14; (b) increasing the pH of the activated manganese dioxide-containing feed water composition sufficient to form a contaminant precipitate and an alkaline solution, wherein the contaminant precipitate comprises at least some of the metal; (d) removing the contaminant precipitate from the alkaline solution to form a treated water, wherein the treated water is purified relative to the feed water composition.

The activated manganese dioxide material may be formed in situ by adding the soluble permanganate ions to the feed water composition where the permanganate will react with the contained proper organic or a proper organic added to the feed water composition, such as glycerin. In the alternative, the activated manganese dioxide can be formed in vitro by reacting the soluble permanganate ions with the proper organic, and the resulting activated manganese dioxide can thereafter be added to the feed water composition.

Optionally, the pH of treated water can be lowered, for example to a pH suitable for transportation or for further industrial use, such as liquid road salt. In addition, either or both the feed water composition and the treated water can be exposed to activated carbon. Further yet, the treated water can be exposed to ultraviolet (UV) light. A method may also optionally comprise recovering the treated water.

A feed water composition may be selected from any generally aqueous fluid composition, according to some embodiments. For example, a feed water composition may include fracking water, flowback water, produced water, industrial wastewater, brackish water, municipal wastewater, drinking waters or combinations thereof (e.g., fracking water, flowback water, produced water or combinations thereof).

A process for contaminant removal may be performed at any desired temperature provided that the subject compositions are fluidic. For example, a method may comprise maintaining a temperature from about 0° C. to about 90° C. Processes for contaminant removal may be practiced, for example, at ambient temperatures.

In some embodiments, contacting a feed water composition with activated manganese dioxide may be performed in situ by contacting the feed water composition with solid sodium permanganate, an aqueous solution of potassium permanganate, an aqueous solution of sodium permanganate, an aqueous solution of calcium permanganate, or combinations thereof. In all cases, sufficient proper organic must be present in the aqueous solution for the formation of the activated manganese dioxide. In cases where there is insufficient or not the proper organic present, an organic, such as glycerin, may be added to the solution. In certain embodiments, the activated manganese dioxide may be prepared in vitro and added to the aqueous solution at this stage.

The proper activated manganese dioxide is formed at conditions of pH greater than about 5.5 up to about 14. Formation of manganese dioxide at low pH, i.e., less than 5.5, or in strong acidic conditions, results in non-activated manganese dioxides which have poor surface area and activities. Use of permanganate in acidic conditions is typically used to remove organic contaminations by oxidation. In the present process, the goal is to form activated manganese dioxide with catalytic properties.

In some embodiments, the organics may be removed from the aqueous solution through evaporation or carbon adsorption on carbon or other materials or processes before adding the proper organic, such as glycerin, for the creation of the activated manganese dioxide. Removing organics from the aqueous solution using non-permanganate techniques before creation of activated manganese dioxide may be preferable, such as in cases where the aqueous solution contains high levels of organics, when the use of permanganates may be cost prohibitive. After the organics are removed using the non-permanganate techniques, an appropriate level of proper organics may be added to the aqueous solution to minimize the amount of permanganate that must be added to create the activated manganese dioxide.

There are two mechanisms by which the activated manganese dioxide removes the metal ions from the alkaline solution. The first is through catalytic action. In the following step, when the pH is increase, the active sites within the manganese structure promotes the precipitation of the metal carbonates to below their Ksp values. The second of these methods is the adsorption value of the active manganese dioxide sites. The active sites bind a portion of the metal ions and are removed from the solution during filtration.

Increasing the pH of the activated manganese dioxide-containing feed water composition sufficient to form a contaminant precipitate and an alkaline solution, in some embodiments, may comprise contacting the permanganate-treated feed water composition with a sufficient amount of a basic aqueous solution comprising sodium carbonate, potassium carbonate, sodium hydroxide, potassium hydroxide, or combinations thereof to increase the pH of the activated manganese dioxide-containing feed water composition to from about pH 5 to about pH 14 (e.g., about pH 11.5 to about pH 14). In some embodiments, a basic solution may comprise one base to the exclusion of other bases or in addition to one or more other bases. For example, a basic solution may comprise only sodium carbonate, only sodium hydroxide, or both sodium carbonate and sodium hydroxide.

Increasing the pH of a activated manganese dioxide-containing feed water composition sufficient to form a contaminant precipitate and an alkaline solution may comprise, in some embodiments, (i) contacting the permanganate-treated feed water composition with a sufficient amount of a first basic aqueous solution comprising sodium bicarbonate to increase the pH of the activated manganese dioxide-containing feed water composition to from about pH 5 to about pH 10.5 (e.g., about pH 8.5 to about pH 10.5), and/or (ii) thereafter contacting the activated manganese dioxide-containing feed water composition-sodium bicarbonate mixture with a sufficient amount of a second basic aqueous solution comprising sodium hydroxide to increase the pH of the mixture to from about pH 10 to about pH 14. The use of sodium bicarbonate is preferred for those aqueous solutions that contain high levels of aluminum. The use of sodium bicarbonate reduces the amount of aluminum hydroxides which are hard to filter. Contacting an activated manganese dioxide-containing feed water composition-sodium bicarbonate mixture with a sufficient amount of a basic aqueous solution comprising sodium hydroxide to increase the pH of the mixture to from about pH 10 to about pH 14 (e.g., about pH 11 to about pH 13) may further comprise contacting the activated manganese dioxide-containing feed water composition-sodium bicarbonate mixture with a sufficient amount of the second basic aqueous solution comprising sodium hydroxide to increase the pH of the mixture to from about pH 10 to about pH 14 (e.g., about pH 11 to about pH 11.5), in some embodiments. Removing a contaminant precipitate from an alkaline solution may comprise, according to some embodiments, separating the alkaline solution and the contaminant precipitate in a settling tank, a centrifuge, a belt filter, a plate-and-frame filter, a multimedia filter, a candle filter, a rotary-drum vacuum filter, or a combination thereof. For example, removing a contaminant precipitate from an alkaline solution may comprise separating the alkaline solution and the contaminant precipitate in a settling tank and a scroll centrifuge.

According to some embodiments, lowering the pH of the treated water may comprise contacting the treated water with an acidic aqueous solution comprising hydrochloric acid. Lowering the pH of the treated water may comprise, for example, lowering the pH to about 5.5 to about 11 and/or lowering the pH to about 7 to about 8.

Treated water may have a sufficient composition (e.g., be sufficiently pure) to be suitable for use as a fracking fluid (a “pre-treated water composition”). A treated water may comprise, for example, less than about 2 ppm barium, less than about 0.3 ppm iron, less than about 10 ppm nitrogen, more than about 250 ppm chloride, more than about 250 ppm total dissolved solids, more than about 1 ppm silica, less than about 15 pCi/L gross alpha, and/or less than about 5 pCi/L total radon.

According to some embodiments, the present disclosure relates to fluid (e.g., water) purification systems. A water purification system may comprise, for example, a feed water vessel (e.g., pipe, tank); a permanganate vessel (e.g., pipe, tank) in fluid communication with the feed water vessel; a first base vessel (e.g., pipe, tank) in fluid communication with the feed water vessel; optionally, a second base vessel (e.g., pipe, tank) in fluid communication with the feed water vessel; a separation vessel (e.g., pipe, tank) in fluid communication with the feed water vessel; a first filtration unit comprising a first inlet in fluid communication with the separation vessel and a first eluate outlet; an acid vessel (e.g., pipe, tank) in fluid communication with the first eluate outlet; a second filtration unit comprising activated carbon, a second inlet in fluid communication with the first eluate outlet, and a second eluate outlet; and an ultraviolet vessel in optical communication with a ultraviolet light source and in fluid communication with the second eluate outlet.

The present disclosure relates, in some embodiments, to fracking methods. A fracking method may comprise (a) combining a pre-treated water composition, sand, and one or more fracking chemicals (e.g., formic acid, boric acid, magnesium peroxide, etc.) to form a fracking fluid; and/or injecting the fracking fluid under pressure into a wellbore.

### BRIEF DESCRIPTION OF THE DRAWINGS

Some embodiments of the disclosure may be understood by referring, in part, to the present disclosure and the accompanying drawing, wherein:

FIG. 1 illustrates a generalized flow diagram according to a specific example embodiment of the disclosure.

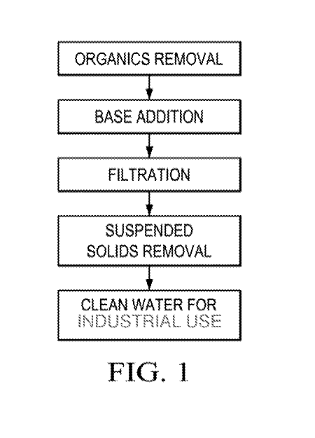

FIG. 2A illustrates a fracking operation comprising an injection well module that generates fracking water, a separation module that generates process water, a treatment modules that generates treated water, and an additive module that supplies additives to the separation module and/or the treatment module, according to a specific example embodiment of the disclosure;

FIG. 2B is a detailed view of the well module included in the fracking operation shown in FIG. 2A;

FIG. 2C is a detailed view of the separation module included in the fracking operation shown in FIG. 2A;

FIG. 2D is a detailed view of the treatment module included in the fracking operation shown in FIG. 2A; and

FIG. 2E is a detailed view of the additive module included in the fracking operation shown in FIG. 2A.

### DETAILED DESCRIPTION

The present disclosure relates, in some embodiments, methods for water purification comprising subjecting contaminated water to one or more chemical purification and/or separation steps to provide a solid contaminant waste and a purified water product. A purified water product may meet or exceed, according to some embodiments, one or more EPA drinking water standards. According to some embodiments, a purified water product may comprise some total dissolved solids (TDS). A TDS may be or may comprise NaCl, potassium chloride (KCl), other trace salts, or combinations thereof. Although not regulated by EPA, silica may be present in the product water in some embodiments. A purified water product may be suitable, in some embodiments, for reuse industrially as fracking water, commercially as a road deicing solution, and/or as a feed for further processing (e.g., an electrolysis system to further purify the water to make it a useful feed to a Chlor-Alkali production facility).

According to some embodiments, a process may comprise improving the quality of contaminated water to EPA drinking water standards as listed below in Table 1. For example, water may be improved, with the exception of chloride and, potentially, total dissolved solids. The water may be obtained from sources comprising fracking water, flowback water, produced water, industrial wastewater, brackish water, municipal wastewater, and drinking waters.

TABLE 1
EPA Drinking Water Standard (in PPM)

| Material | EPA Standard |
|---|---|
| Barium | 2 |
| Iron | 0.3 |
| Total Nitrogen | 10 |
| Chloride | 250 |
| Total Dissolved Solids (Not including Na or Cl) | 250 |
| Gross Alpha (pCi/L) | 15 |
| Total Ra (pCi/L) | 5 |

According to some embodiments, the present disclosure relates to water treatment processes. For example, a process may comprise optionally pre-treating the water (e.g., by filtration), optionally contacting the water with soluble permanganate ions (MnO₄⁻) in the presence of proper organics to form an activated manganese dioxide, or contacting the water with an activated manganese dioxide that was formed in vitro; optionally contacting the water with soluble carbonate ions (CO₃²⁺) (e.g., to increase the pH of the solution) forming a precipitate; optionally contacting the water with soluble hydroxide ions (OH) (e.g., to further increase the pH of the solution) forming a further precipitate; optionally removing the precipitated solids from the alkaline solution for example by filtering the water to form a treated water; optionally lowering the pH of the treated water, for example, by contacting it with an acid (e.g., HCl), to form a reduced pH treated water; optionally exposing the reduced pH treated water to activated carbon and/or an ultraviolet (UV) light and separating any precipitate formed from the reduced pH treated water; and/or recovering the treated water or the reduced pH treated water as a product.

According to some embodiments, the order of the steps may change and/or one or more steps may be combined or eliminated. In certain embodiments, subjecting the water to UV purification and/or carbon filtration may be accomplished prior to any other steps. In some embodiments, water may be contacted with permanganate ions simultaneously with carbonate ions. In some embodiments, raising the pH of water may be accomplished using either carbonate ions or hydroxide ions, exclusively.

According to some embodiments, methods may be performed at a gas or oil Fracking well site using a mobile processing module. For example, equipment may be installed on one or more movable platforms including skids, trailer flatbeds, and/or enclosed trailers. Equipment may also be stationary and/or mounted to fixed temporary foundations.

Embodiments of the present disclosure may have one or more desirable qualities (e.g., desirable over existing methods and systems). For example, water (e.g., fracking water) may be treated, according to some embodiments, with desirable cost effectiveness by circumventing the use of energy intensive and expensive evaporation steps, requiring no further dilution of flowback or produced waters, and/or producing an easily disposable solid waste (e.g., compared to filtered sludge produced by existing methods). In addition, systems and method may remove, according to some embodiments, unwanted ions from contaminated water so that the clean water may be recycled for use in a fracking process. All salts (e.g., salts of sodium, potassium, calcium, manganese, magnesium) and silica, when present in the water, will result in a stable solution that will allow safe and easy transportation for reintroduction into wells. This may lower the amount of fresh water consumed by fracking processes.

According to some embodiments, the disclosure relates to a process for treating water. A process may include a pre-treatment if desired. For example, water to be treated may be pre-filtered (e.g., through a ceramic or other membrane having a pore size of about 10μ to about 50μ). Pre-filtration may be desirable where the contaminated media to be treated comprises particles including, for example, radioactive particles (e.g., radium and/or uranium). Pre-filtration may be configured such that filtered or eluted water is substantially free of radioactive materials. A process may comprise, for example, contacting water (e.g., contaminated fluid water) with soluble permanganate ions (MnO₄⁻) (e.g., a source of MnO₄⁻ ions). Contact of the permanganate ion, to facilitate the precipitation process, must be with a suitable organic material necessary to form the proper activated manganese dioxide. Glycerin has proven to be a suitable material to produce the proper activated manganese dioxide. Glycerin should be added as the water solution prior to addition of the permanganate solution because addition of glycerin to solid permanganates is hazardous. In those metal ion containing waters where there is no organic or not enough, the proper organic must be added.

Experimentation has shown for Marcellus produced water the minimum amount of glycerin necessary may be as low as about 200 ppm, but 500 to 1000 has shown better results. In some embodiments, the proper organics may be provided with a concentration of about 100 ppm or about 200 ppm to about 1000 ppm. Additional organic increases the permanganate demand, which is the most expensive constituent. The most desired manganese dioxide form is the gamma form, although the alpha or delta form may produce acceptable results. The desired manganese dioxide has a surface area of more than about 100 square meters per gram, or more than about 200 square meters per gram, when acid washed and tested. It also has a pore size sufficient to exchange the metal ions, for example, a pore size of about 3 to about 20 nm in diameter, or of about 3 to about 200 nm in diameter. The process begins with water above a pH of 5.5 making carbon steel a suitable material of construction. Formation of the activated manganese dioxide should be at a pH above 5, or between about 5.5 and 14. Activated manganese dioxide formed under these conditions allows the removal of metal ions upon the addition of carbonite to below their soluble levels as shown in the Ksp values. In contrast, the formation of manganese dioxide at a lower pH favors the delta or the beta material, which has lower pore volumes and may not remove the residual metal ions to below Ksp values. The delta and beta form of manganese dioxide do not have the same catalytic properties as the alpha and gamma forms. Once the activated manganese dioxide is formed, a neutralizing agent is added (such as sodium bicarbonate or sodium carbonate, depending upon the other ions in the solution) to precipitate most divalent heavy metal ions such as nickel, copper barium, strontium. The hardest ion to separate is the alumina ion. If sodium carbonate is used, the disassociation of water in the solution is sufficient for form aluminum hydroxides. Aluminum hydroxides slime, hold up significant amounts of water, and form hydrated compounds. The lower ionic strength of sodium bicarbonate may be a material of choice in forming the resulting carbonates to prevent sliming. The carbonate, either bicarbonate or carbonate, with the proper activated manganese dioxide will form the sodium form of the manganese dioxide with the sodium ions filling the active sites in the activated manganese dioxide. A process also may comprise increasing the pH of water to permit and/or cause precipitation of one or more contaminants. In some embodiments, a process may comprise separating water and precipitated solids (e.g., gravity separation). A process may include filtering water to remove suspended solids. In addition, a process may include lowering the pH (e.g., to a more neutral pH). A treatment process may further include carbon filtration and/or ultraviolet (UV) purification. Upon completion of some or all of these steps, the resulting treated water may be recovered as a product.

According to some embodiments, a feed composition for a water treatment process may include waters produced by fracking processes (e.g., fracking water, flowback water, and/or produced water), industrial wastewater, brackish water, municipal wastewater, and/or drinking waters. For example, a feed composition for a water treatment process may be selected from fracking water, flowback water, produced water, and/or combinations thereof. Although some embodiments have been developed in the context of methods for recovering, purifying, and reusing waters used and produced in hydraulic fracturing processes, embodiments of the disclosure may be applied to and/or adapted to various water sources and may accomplish significant softening and decontamination of any treated water source.

Methods of water treatment may be performed, in some embodiments, at any desired temperature and/or any desired pressure. For example, methods may be performed at all temperatures over which water is in liquid form (e.g., about 0° C. to about 90° C.). Methods may be performed, in some embodiments, at temperatures of about ambient (e.g., 20° C.) to about 90° C. Temperature and/or pressure may remain substantially constant or may independently vary during a treatment process.

According to some embodiments, contacting water with permanganate may be performed with any source of permanganate ions desired including, for example, any desired salt of permanganate. Contacting water with permanganate ions may comprise, in some embodiments, contacting water with a source of soluble permanganate ions (MnO₄⁻) selected from an aqueous solution of potassium permanganate and/or sodium permanganate. A source of permanganate ions may include calcium permanganate, for example, where residual calcium is not problematic and/or is removed in a later step. An aqueous permanganate solution may comprise about 0.1 to about 40 wt % (e.g., about 0.1 to about 10 wt %, about 0.1 to about 20 wt %, or about 1 wt % to about 30 wt %) potassium permanganate, sodium permanganate or mixtures thereof according to some embodiments. For example, an aqueous permanganate solution may comprise about 0.1 to about 7 wt % potassium permanganate, sodium permanganate, or mixtures thereof. In some embodiments, a source of permanganate ions may comprise a permanganate solid (e.g., sodium permanganate monohydrate). The presence of organic compounds combined with the presence of the permanganate ions (e.g., MnO₄⁻) may form an activated manganese dioxide which has an affinity to adsorb metal ions such as nickel and copper and many others, according to some embodiments.

Without limiting any particular embodiment(s) of the disclosure to any specific mechanism of action, it has been discovered that exposure of feed water to a soluble permanganate source may be associated with, may permit, and/or may cause (collectively, “may permit”) formation of complexes of the permanganate ion with manganese dioxide. These complexes then become available to cause oxidation of various contaminants in solution, more specifically the permanganate-manganese dioxide complexes may oxidize iron and/or sulfur, if present in the contaminated water. The permanganate ions also have the ability to absorb other metal species from solution (e.g. Nickel, Copper) by forming transition metal complexes in solution to the extent that permanganate is available.

In some embodiments, increasing solution pH may be associated with, may permit, and/or may cause (collectively, “may permit”) precipitation of contaminants. Increasing solution pH may comprise contacting water with an aqueous solution comprising any base(s) including, for example, sodium carbonate, sodium hydroxide, potassium carbonate, potassium hydroxide, or combinations thereof. In some embodiments, increasing solution pH may comprise contacting water with an aqueous solution comprising sodium carbonate, sodium hydroxide, or combinations thereof. Increasing solution pH may comprise increasing the pH to about 7 to about 14 (e.g., about 7 to about 9, about 8 to about 10, about 9 to about 11, about 10 to about 12, about 11 to about 13, about 12 to about 14, about 11 to about 11.5) to permit precipitation of contaminants. In some embodiments, increasing solution pH may comprise contacting water with an aqueous solution of sodium carbonate (e.g., to a pH of about 8.5 to about 10.5) followed by contacting the solution with an aqueous solution of sodium hydroxide (e.g., to a pH of about 11 to about 14; to a pH of about 11 to about 11.5) to permit precipitation of contaminants. In some embodiments, increasing solution pH may comprise contacting water with an aqueous solution of sodium hydroxide (e.g., to a pH of about 8.5 to about 10.5) followed by contacting the solution with an aqueous solution of sodium carbonate (e.g., to a pH of about 11 to about 13; to a pH of about 11 to about 11.5) to permit precipitation of contaminants. In some specific example embodiments tested, performance of the former order surpassed performance of the latter order.

Separating water and solid precipitates may comprise, in some embodiments, separating a mixture of water and precipitated solids using a settling tank, a centrifuge, a belt filter, a plate-and-frame filter, a multimedia filter, a candle filter, a rotary-drum vacuum filter, or combinations thereof.

Separating water and precipitated solids may comprise separating water and precipitated solids in a settling tank and a centrifuge (e.g., a scroll centrifuge) in some embodiments. For example, separating water and precipitated solids may comprise separating water and precipitated solids in a settling tank into a decanted water fraction and wet solids fraction, and separating the wet solids fraction in a centrifuge to produce dewatered solids and a liquid solution. The liquid solution may be recycled to an earlier step in the process. The liquid solution may be recycled, for example, to the step which increases the pH of the water to precipitate solids.

Without limiting any particular embodiment(s) of the disclosure to any specific mechanism of action, it has been discovered that a purified water component may be produced after contaminants are precipitated by pH adjustment by using a solid-liquid separation technique. For example, a settling tank may be used to separate water and precipitated solids into a decanted water fraction and a wet solids fraction. According to some embodiments, wet solids fraction may be sent to a centrifuge and separated into dewatered solids and a supernatant solution. Dewatered solids may be collected and/or supernatant solution may be recycled to the step in the process in which pH is raised to precipitate solids. Performing a method in this way may provide desirable flexibility in the separation, for example, where the combination of a settling tank and a centrifuge allow for a small footprint and/or allow better solid liquid separation if slimy solids are produced on precipitation.

According to some embodiments, filtration to remove suspended solids may comprise passing water through one or more multimedia filters, sand filters, screen filters, disk filters, cloth filters, or combinations thereof. For example, filtration to remove suspended solids may comprise passing water through a sand filter, which may be desirable in that a sand filter offers simple operation, a small footprint, and the ability to operate without a filter aid.

Exposing water to an acidic component to lower (e.g., neutralize) pH may comprise, in some embodiments, combining the water with a sufficient volume of an aqueous solution of sufficient acid concentration to reduce the pH of the water. For example, water may be exposed to hydrochloric acid (HCl) in order to neutralize the pH of the solution. The pH of the water after contact with the acid solution may be reduced to about 5.5 to about 11 (e.g., about 7 to about 8). Hydrochloric acid may be a desirable acid for neutralization step as it is expected to produce primarily the harmless monovalent salt species NaCl and KCl upon neutralization.

In some embodiments, carbon filtration and/or ultraviolet (UV) purification may be carried out at the end of the process to remove trace organic contaminants as well as biologically active contaminants. Carbon filtration and/or ultraviolet (UV) purification may be included prior to permanganate exposure and prior to alkaline precipitation according to some embodiments.

According to some embodiments, a process may optionally include ion exchange chromatography (e.g., cation exchange chromatography). For example, cation exchange chromatography may be included prior to processing (e.g., before contacting feed water with permanganate), at any point during processing (e.g., after contacting feed water with permanganate and before ultraviolet light exposure), or after processing.

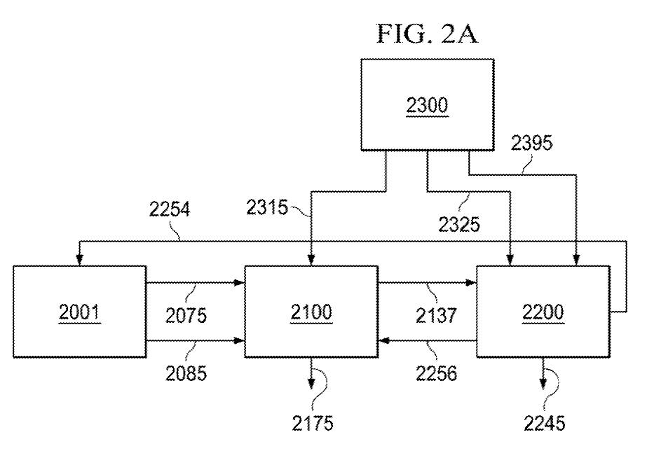

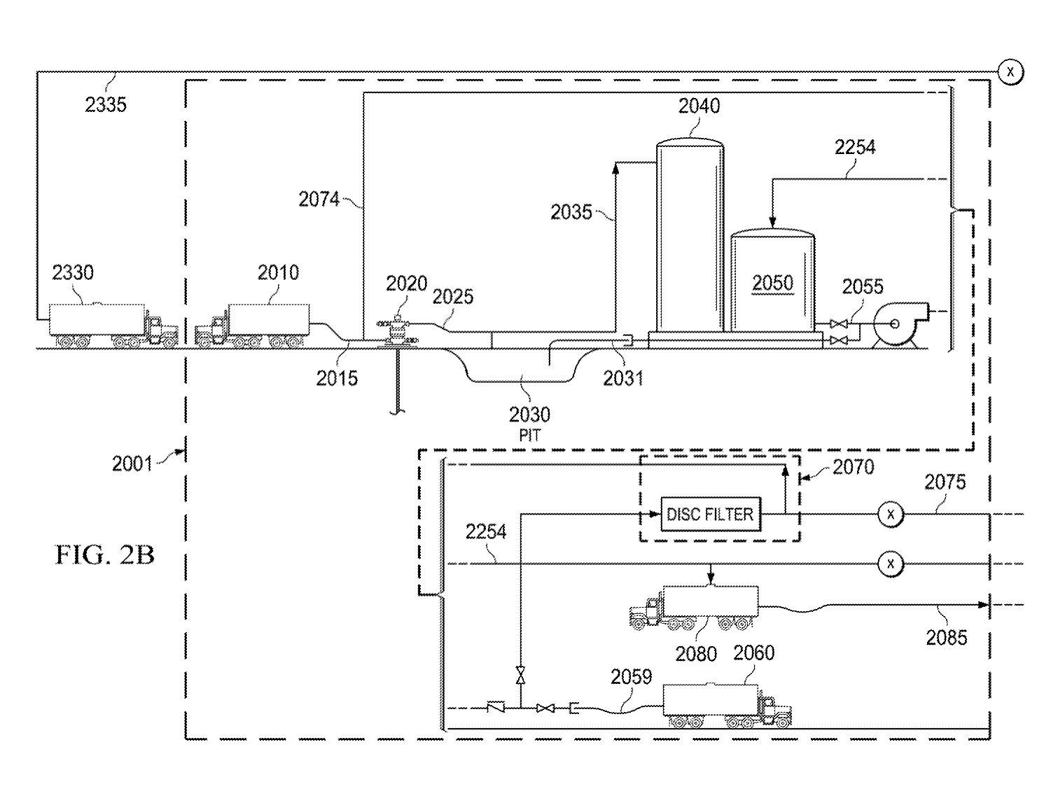

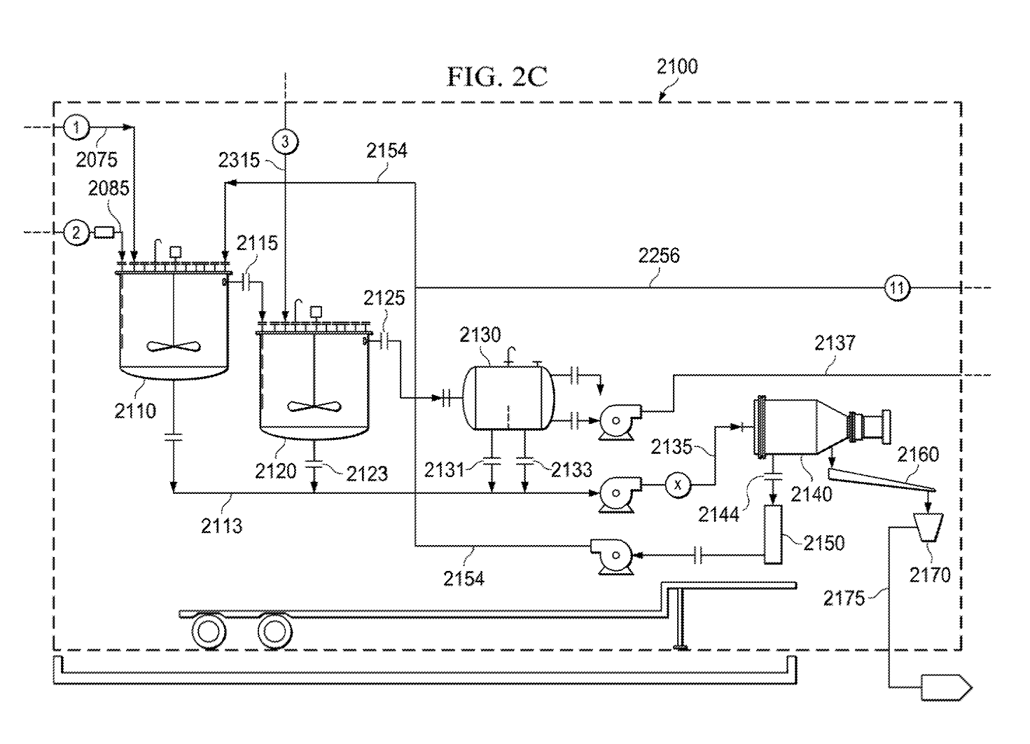

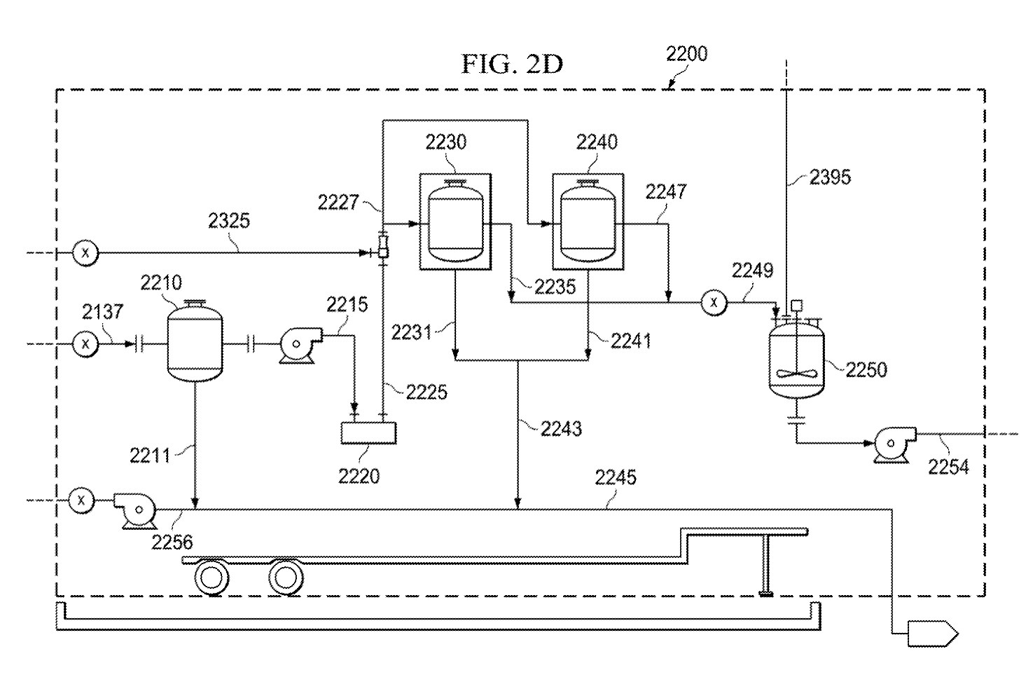

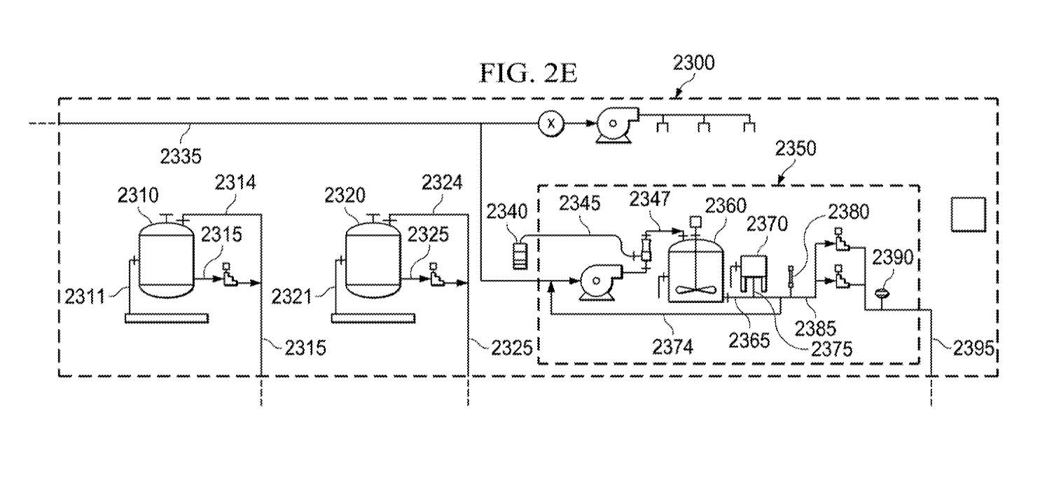

A water treatment process, in some embodiments, may be included in a fracking operation comprising an injection well module that generates fracking water, a separation module that generates process water, a treatment module that generates treated water, and an additive module that supplies additives to the separation module and/or the treatment module, according to a specific example embodiment of the disclosure. A specific example embodiment of a fracking operation is shown in FIGS. 2A-2E, which may be modified for use in purifying any contaminated water from any source. As shown in FIG. 2A, Fracking operation 2000 as shown comprises (a) well module 2001 that generates fracking water 2075, (b) treatment/separation module 2100 that receives fracking water 2075 and generates process water 2137, (c) filtration module 2200 that receives process water 2137 and produces treated water 2254, and/or (d) additive module 2300 that delivers additive stream 2315 to separation module 2100 and additive streams 2325 and 2395 to treatment module 2200. Well module 2001 may also receive treated water 2075 from treatment module 2200 and/or produce soda ash 2085 as shown. Separation module 2100 may also produce sludge water 2155 and/or solid waste 2175 as shown. Treatment module 2200 may also produce waste 2245 as shown.

FIG. 2B is a detailed view of the well module included in the fracking operation shown in FIG. 2A. As illustrated, well module 2001 comprises tank 2010, well injection 2020, (c) fluid reservoir 2030, (d) storage tank 2040, storage tank 2050, waste disposal 2060, filter unit 2070, and soda ash wet mix tank 2080.

FIG. 2C is a detailed view of the separation module included in the fracking operation shown in FIG. 2A. As shown, separation module 2100 comprises chemical mix tank 2110, chemical mix tank 2120, chemical settler 2130, scroll centrifuge 2140, stand pipe 2150, chute 2160, and dump box 2170. Separation module 2100 may be configured to fit on a single skid, for example, on a flat bed trailer as shown.

FIG. 2D is a detailed view of the treatment module included in the fracking operation shown in FIG. 2A. Treatment module 2200, as shown, comprises filter 2210, ultraviolet disinfection unit 2220, carbon bed filter 2230, carbon bed filter 2240, and mix tank 2250. Treatment module 2200 may be configured to fit on a single skid, for example, on a flat bed trailer as illustrated.

FIG. 2E is a detailed view of the additive module included in the fracking operation shown in FIG. 2A. Additive module 2300 comprises additive feed tank 2310, additive feed tank 2320, clean wash water tank 2330, additive source 2340, and additive unit 2350, as shown. Additive unit 2350 comprises additive tank 2360, additive day tank 2370, column 2380, and pulsation dampener 2390. Additive module 2350 may be configured to fit on a single skid, for example, on a flat bed trailer, as shown.

Tank 2010 may contain/produce drilling fluid 2015 that is conveyed to well injection 2020 and injected in an aquifer to yield fracking water 2025. Fluid reservoir 2030 may receive fracking water 2025 and/or produce flowback and/or produced water. Flowback and/or produced water may be combined with fracking water 2025 to form stream 2035. Solids 2031 (e.g., solids and/or fluid enriched in solid content) in a lower portion of fluid reservoir 2030 may be removed, optionally combined with stream 2055 from tank 2050 to form stream 2059, and/or conveyed to waste disposal 2060. Streams 2031 and/or 2055 may be combined to form stream and conveyed to disc filter unit 2070. Filtrate may be returned by stream to well injection or conveyed in stream 2075 to mix tank 2110. Soda ash 2085 may also be conveyed from tank 2080 to mix tank 2110. Stream 2115 (e.g., containing fewer particulates than stream 2113) may be conveyed from tank 2110 to mix tank 2120. Mix tank 2120 may receive additive 2315 from additive tank 2310. Stream 2314 may be combined with stream 2315. Stream 2311 may be received from and/or by additive tank 2310. Stream 2125 (e.g., containing fewer particulates than stream 2123) may be conveyed from tank 2120 to settler 2130. Process water 2137 may emerge from settler 2130 after settling. Solids 2131 and/or solid enriched fluid 2133 may be combinded with stream 2113 from tank 2110 and/or stream 2123 from tank 2120 to form stream 2135. Stream 2135 may be conveyed to scroll centrifuge 2140 and separated into stream 2144 and stream 2145 (not pictured). Stream 2144 may be conveyed to stand pipe 2150. Stream 2154 may be conveyed from stand pipe 2150 to mix tank 2110 for further. Stream 2145 (not pictured) may contain substantial quantities of solids and may be conveyed via chute 2160 to dump box 2170. Stream 2175 may be conveyed as solid waste to, for example, a land file or other disposal site.

Process water 2137 may be passed through filter 2210 to form clean out 2211 and filtrate 2215. Filtrate 2215 may be conveyed to ultraviolet unit 2220 for UV treatment to form stream 2225. Stream 2225 may be combined with additive 2325 from tank 2320 to form stream 2227, which may be conveyed to carbon filters 2230 and/or 2240. Stream 2324 may be combined with stream 2325. Stream 2321 may be received from and/or by additive tank 2320. Filtrate streams 2235 and 2247 may be combined to form stream 2249 and conveyed to mix tank 2250. Tank 2250 may receive additive 2395 from tank 2360 and form treated water stream 2254. Stream 2243 may be collected as treated water, returned to storage tank 2050 (e.g., for recycling back to well injection 2020 via streams 2057 and 2074) and/or returned to soda ash tank 2080.

Clean out wastes 2231 and 2241 may be combined to form stream 2243, which may be further combined with clean out 2211 to form sludge water 2256. Sludge water 2256 may be conveyed to mix tank 2110. Stream 2243 and 2211 may be combined to form stream 2245. Stream 2245 may be conveyed (e.g., as solid waste) to, for example, a pit or other disposal site.

Additive unit 2350 may be configured to process and deliver permanganate to filtration unit 2200. Unit 2350 may receive clean wash water 2335 from tank 2330. Clean water 2335 may be combined with additive stream 2345 and/or recycle stream 2374 to form stream 2347 and conveyed to mix tank 2360. Additive 2375 may be combined with stream 2365 from tank 2360 to form stream 2385. Stream 2385 may be metered and/or dampened to form stream 2395.

Column 2380 is a calibration column configured to check pump flow rates, which may improve system accuracy. Pulsation dampener 2390 reduces flow fluctuations and line vibrations caused by diaphragm pumps.

As will be understood by those skilled in the art who have the benefit of the instant disclosure, other equivalent or alternative compositions, devices, methods, and systems for purifying feed water compositions can be envisioned without departing from the description contained herein. Accordingly, the manner of carrying out the disclosure as shown and described is to be construed as illustrative only.

In some embodiments, the size of a device and/or system may be scaled up (e.g., for a high processing rate) or down (e.g., for portability) to suit the needs and/or desires of a practitioner. Each disclosed method and method step may be performed in association with any other disclosed method or method step and in any order according to some embodiments. Where the verb “may” appears, it is intended to convey an optional and/or permissive condition, but its use is not intended to suggest any lack of operability unless otherwise indicated. Persons skilled in the art may make various changes in methods of preparing and using a composition, device, and/or system of the disclosure. For example, a composition, device, and/or system may be prepared and or used as appropriate for fracking or other applications (e.g., with regard to pH, purity, and other considerations). Elements, compositions, devices, systems, methods, and method steps not expressly recited may be included or excluded as desired or required.

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value+/−about 10%, depicted value+/−about 50%, depicted value+/−about 100%) and/or a range endpoint. With respect to the former, a value of 50 depicted in an example, table, and/or drawing may form the basis of a range of, for example, about 45 to about 55, about 25 to about 100, and/or about 0 to about 100. Disclosed percentages are weight percentages except where indicated otherwise.

All or a portion of a device and/or system for purifying feed water compositions may be configured and arranged to be disposable, serviceable, interchangeable, and/or replaceable. These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

The title, abstract, background, and headings are provided in compliance with regulations and/or for the convenience of the reader. They include no admissions as to the scope and content of prior art and no limitations applicable to all disclosed embodiments.

### Examples

Some specific example embodiments of the disclosure may be illustrated by one or more of the examples provided herein.

### Example 1: Water Purification Process

Treating a contaminated water composition may comprise:
contacting the contaminated water composition with an aqueous solution of 0.1-7% permanganate ions by weight in the presence of a proper organic, such as glycerin with a concentration of up to 1000 ppm to form an activated manganese dioxide, or adding an activated manganese dioxide that was formed in vitro to the contaminated water composition;
contacting the water with an aqueous solution of carbonate ions to increase the pH of the water to between 8.5-10.5
contacting the water with an aqueous solution of hydroxide ions to increase the pH of the water to between 11-14 to induce further precipitation of solids
separating the water and precipitated solids into a decanted water fraction and wet solids fraction using a settling tank, further separating the wet solids using a centrifuge into a supernatant liquid and dewatered solids, and recycling the supernatant liquid to be contacted with said aqueous solution of carbonate ions
exposing said decanted water fraction from the settling tank to filtration in a sand filter to remove suspended solids
contacting said decanted water fraction with an aqueous hydrochloric acid (HCl) solution to neutralize the pH of the water to 5.5-11
exposing said decanted water fraction to carbon filtration after HCl neutralization
exposing said decanted water fraction to ultraviolet sterilization after carbon filtration
recovering said decanted water fraction as a product for reuse as a fracking fluid with the following properties:
   <2 ppm barium
   <0.3 ppm iron
   <10 ppm nitrogen
   >250 ppm chloride
   >50 ppm total dissolved solids (excluding sodium and chloride ions)
   >1 ppm silica
   <15 pCi/L Gross alpha
   <5 pCi/L total Ra

### Example 2: Water Purification Performance

A treated water composition may be prepared according to the process of Example 1. Treated water recovered from the purification method may have substantially greater than zero silica content and may meet the EPA drinking water standard in every aspect with the possible exception of chlorides and total dissolved solids content as shown in Table 2. below:

TABLE 2
Prophetic Example compared to EPA
Drinking Water Standard (in PPM)

| Material | EPA Standard | Product Water |
|---|---|---|
| Barium | 2 | <2 |
| Iron | 0.3 | <0.3 |
| Total Nitrogen | 10 | <10 |
| Chloride | 250 | >250 |
| Silica | N/A | >1 |
| Total Dissolved Solids (Not including | 250 | >50 |
| Na or Cl) | | |
| Gross Alpha (pCi/L) | 10 | <15 |
| Total Ra (pCi/L) | 5 | <5 |

### Example 3: Water Purification Process and Performance

Contaminated fracking water was treated as follows.
An initial sample of 1200 mL of unfiltered frac water had an initial pH of 7.23. This initial sample was black in color.
13.7 g of Na₂CO₃ (s) was added and stirred for 5 min, the resulting solution was a light gray-brown color with a pH=10.39.
24.7 g of 50% NaOH was added and stirred for 5 min to give a pH=13.02, the mixture was light gray in color with suspended particles which can be seen while mixing.
Agitation was ceased and the particles appeared to agglomerate.
The mixture was filtered using Whatman 3 paper (6 μm), the filtrate was very clear and had a yellow tint.
35.7 g of 36% HCl was added to the filtrate to lower the pH to 7.61, which turned the filtrate a dark green color.
20 g of activated carbon was added to the neutral filtrate solution and stirred for 5 min.
This mixture was filtered twice to remove all the suspended carbon (Whatman 3 (6 μm) filter paper was used).
400 mL of the filtrate was sampled and 22 drops of KMnO₄ (0.047 g/mL) was added, which initially turned the mixture a slight purple/pink/chocolate opaque color, after 30 sec of stirring, the mixture was brown/yellow opaque in color.
This was centrifuged for 5 min at setting 7, the resulting solution was clear with a very slight yellow tint and a small amount of dark brown solids had accumulated in the bottom of the centrifuge tube.
   The obtained solution was assayed for compliance with EPA drinking water standard and results are shown in Table 3.

TABLE 3
Working Example of Unfiltered Water
Treated and Untreated (in PPM)

| Metals | Treated Frac Water | Untreated |
|---|---|---|
| Silver | ND | ND |
| Aluminum | ND | 0.86 |
| Arsenic | ND | ND |
| Boron | 0.12 | 0.15 |
| Barium | ND | 1.76 |
| Beryllium | ND | ND |
| Calcium | 1.95 | 1750 |
| Cadmium | ND | ND |
| Cobalt | ND | ND |
| Chromium | ND | 0.79 |
| Copper | ND | ND |
| Iron | ND | 3.4 |
| Potassium | 633 | 337 |
| Magnesium | 0.3 | 30 |
| Manganese | 0.41 | 0.08 |
| Molybdenum | 0.08 | 0.16 |
| Mercury | | |
| Sulfur | 84.2 | 258 |
| Sodium | 16760 | 5095 |
| Niobium | ND | ND |
| Nickel | ND | ND |
| Lead | ND | ND |
| Antimony | ND | ND |
| Selenium | ND | ND |
| Silicon | 12.1 | 20.8 |
| Tin | 0.1 | ND |
| Strontium | 0.2 | 68.2 |
| Tantalum | ND | ND |
| Titanium | ND | ND |
| Vanadium | ND | ND |
| Zinc | 0.1 | ND |
| Zirconium | ND | ND |
| Lithium | 1.41 | 1.6 |
| Phosphorus | | 1.1 |
| TOC | 110 | 661 |

### Example 4: Water Purification Process and Performance

Contaminated fracking water was treated as follows.
An initial sample of 1000 mL of filtered frac water had an initial pH of 7.26. This initial sample was clear with floating brown particulate, which appeared to be agglomerated.
This sample was filtered using Whatman 3 paper (6 μm).
The filtrate was collected and 0.4 g of KMnO₄ (0.047 g/mL) solution was added and stirred for 5 min, the resulting solution was a yellow/pink color with a pH of 7.08.
2.3 g of Na₂CO₃ (s) was added to this solution and stirred for 1 min, the resulting pH was 10.7.
12.3 g of 50% NaOH was added and stirred for 1 min to give a pH=12.5.
Agitation was ceased and the particles appeared to agglomerate.
The mixture was filtered using Whatman 3 paper (6 μm), the filtrate was very clear and had a very slight yellow tint, 5 g of solids+residual water was filtered, the solids were not dried.
To the filtrate, 16.8 g of 36% HCl was added and stirred for 1 min to lower the pH to 7.31.
Activated carbon was added to the neutral filtrate solution and stirred for 5 min. This mixture was filtered to remove all the fine suspended carbon particles (Whatman 3 (6 μm) filter paper was used).
   The obtained solution was assayed for compliance with EPA drinking water standard and results are shown in Table 4.

TABLE 4
Working Example of Pre-Filtered Frac
Water, Treated and Untreated (in PPM)

| Metals | Treated Frac Water | Untreated |
|---|---|---|
| Aluminum | ND | 0.23 |
| Arsenic | ND | ND |
| Boron | 0.179 | 0.31 |
| Barium | 0.007 | 58.65 |
| Beryllium | ND | ND |
| Calcium | 0.361 | 280 |
| Cadmium | ND | ND |
| Chromium | ND | ND |
| Copper | ND | ND |
| Iron | ND | 13.11 |
| Potassium | 151 | 10.16 |
| Magnesium | 0.05 | 21.33 |
| Manganese | ND | 0.42 |
| Molybdenum | ND | ND |
| Mercury | 0.001 | ND |
| Sulfur | 4 | 2.2 |
| Sodium | 5020 | 593 |
| Lead | ND | ND |
| Antimony | ND | ND |
| Selenium | ND | ND |
| Silicon | 1.2 | 2.62 |
| Tin | ND | ND |
| Strontium | 0.7 | 49.68 |
| Zinc | ND | 0.21 |

What is claimed is:

1. A method for purifying a feed water composition comprising a metal, the method comprising the steps of:
contacting the feed water composition with an activated manganese dioxide to form an activated manganese dioxide-containing feed water composition, where the activated manganese dioxide was formed by contacting soluble organics with soluble permanganate ions (MnO₄⁻) at a pH from about 5.5 to about 14;
increasing the pH of the activated manganese dioxide-containing feed water composition sufficient to form a contaminant precipitate and an alkaline solution, wherein the contaminant precipitate comprises at least some of the metal; and,
removing the contaminant precipitate from the alkaline solution to form a treated water, wherein the treated water is purified relative to the feed water composition.

2. A method according to claim 1, wherein the activated manganese dioxide has a surface area of more than about 100 square meters per gram.

3. A method according to claim 1, wherein the activated manganese dioxide has a pore diameter from about 3 nm to about 200 nm.

4. A method according to claim 1, wherein the soluble organics have a concentration from about 100 ppm to about 1000 ppm.

5. A method according to claim 1, wherein the feed water composition comprises fracking water, flowback water, produced water, industrial wastewater, brackish water, municipal wastewater, drinking waters or combinations thereof.

6. A method according to claim 1 further comprising maintaining a temperature from about 0° C. to about 90° C.

7. A method according to claim 1, further comprising the step of forming the activated manganese dioxide in situ by contacting the feed water composition with solid sodium permanganate, an aqueous solution of potassium permanganate, an aqueous solution of sodium permanganate, an aqueous solution of calcium permanganate, or combinations thereof.

8. A method according to claim 1, further comprising the step of forming the activated manganese dioxide in vitro prior to the step of contacting the feed water composition with the activated manganese dioxide.

9. A method according to claim 1, wherein the step of increasing the pH of the activated manganese dioxide-containing feed water composition comprises contacting the activated manganese dioxide-containing feed water composition with a sufficient amount of a basic aqueous solution comprising sodium carbonate, potassium carbonate, sodium hydroxide, potassium hydroxide, or combinations thereof to increase the pH of the activated manganese-containing feed water composition to from about pH 11 to about pH 14.

10. A method according to claim 9, wherein the basic aqueous solution comprises sodium hydroxide.

11. A method according to claim 1, wherein the step of increasing the pH of the activated manganese dioxide-containing feed water composition comprises:
contacting the activated manganese dioxide-containing feed water composition with a sufficient amount of a first basic aqueous solution comprising sodium bicarbonate to increase the pH of the activated manganese dioxide-containing feed water composition to from about pH 8.5 to about pH 10.5; and subsequently
contacting the activated manganese dioxide-containing feed water composition with a sufficient amount of a second basic aqueous solution comprising sodium hydroxide to increase the pH of the activated manganese dioxide-containing feed water composition to from about pH 11 to about pH 14.

12. A method according to claim 11, wherein the step of contacting the activated manganese dioxide-containing feed water composition with the second basic aqueous solution increases the pH of the activated manganese dioxide-containing feed water composition from about pH 11 to about pH 11.5.

13. A method according to claim 1, wherein the step of removing the contaminant precipitate from the alkaline solution comprises separating the alkaline solution and the contaminant precipitate in a settling tank, a centrifuge, a belt filter, a plate-and-frame filter, a multimedia filter, a candle filter, a rotary-drum vacuum filter, or a combination thereof.

14. A method according to claim 1, wherein the step of removing the contaminant precipitate from the alkaline solution comprises separating the alkaline solution and the contaminant precipitate in a settling tank and a scroll centrifuge.

15. A method according to claim 1, further comprising the step of lowering the pH of the treated water by contacting the treated water with an acidic aqueous solution comprising hydrochloric acid.

16. A method according to claim 1, further comprising the step of lowering the pH of the treated water from about 5.5 to about 11.

17. A method according to claim 1, further comprising the step of lowering the pH of the treated water from about 7 to about 8.

18. A method according to claim 1, further comprising one or both steps of: exposing the feed water composition to a first activated carbon before contacting the feed water composition with activated manganese dioxide; and, exposing the treated water to a second activated carbon.

19. A method according to claim 16, wherein the treated water is suitable for use as a fracking fluid.

20. A method according to claim 16 wherein the treated water is suitable for use as a liquid road salt.

21. A method according to claim 1 further comprising performing ion exchange chromatography before or after contacting the feed water composition with the activated manganese dioxide.

22. A method according to claim 1 wherein the contaminant precipitate comprises a radioactive material.
